(19) United States
(12) Patent Application Publication
(10) Pub. No.: US 2015/0314392 A1
(43) Pub. Date: Nov. 5, 2015

(54) Method for Stitch-Welding a Front Flange Joint

(71) Applicants: Scansonic MI GmbH, Berlin (DE); Volkswagen AG, Wolfsburg (DE)

(72) Inventors: Igor Haschke, Berlin (DE); Meinulf Hinz, Berlin (DE); Arwed Kilian, Ludwigsfelde (DE); Steffen Walter, Berlin (DE); SÃren Schiwy, Braunschweig (DE); Thorge Hammer, Tappenbeck (DE)

(21) Appl. No.: 14/379,751

(22) PCT Filed: Feb. 7, 2013
(86) PCT No.: PCT/DE2013/100043

§ 371 Date: Aug. 20, 2014

(30) Foreign Application Priority Data
Feb. 20, 2012 (DE) 10 2012 101 355.1
May 21, 2012 (DE) 10 2012 104 362.0

(51) Int. Cl. B23K 26/26; B23K 26/04; B23K 26/10

(52) U.S. Cl. CPC B23K 26/26; B23K 26/10; B23K 26/043

(57) ABSTRACT

The invention relates to a method by which stitch welds (5) can be produced on the front faces of metal sheets (preferably on flanges) by means of laser welding. In order to produce the stitch weld seam, the following steps are repeated cyclically: pre-heating the joining partners (1, 2) in an area in front of the stitch weld seam to be produced, producing a short stitch weld section (7) at a relatively low resulting welding speed, and producing a section without a weld seam, as a result of which in each case an intermediate space (9) is formed between neighbouring stitch weld sections (7). The ratio of the lengths (6, 8) of intermediate spaces (9) and stitch weld sections (7) is selected in such a way that a degassing is achieved to such an extent that a high quality of the stitch weld seam (5) is achieved. The method is particularly suitable for producing welded joints between galvanized, heat-treated steel sheets, as are often used in automobile manufacture/vehicle body construction.

### CROSS REFERENCE TO RELATED APPLICATIONS

This application is the U.S. national stage of International Application No. PCT/DE2013/100043 filed on Feb. 7, 2013, and claims the benefit thereof. The international application claims the benefit under 35 USC 119 of German Application Nos. DE 10 2012 101 355.1 filed on Feb. 20, 2012; and DE 10 2012 104 362.0 filed on May 21, 2012; all applications are incorporated by reference herein in their entirety.

### BACKGROUND

The invention relates to a method by which stitch welds can be produced on the front faces of metal sheets, preferably on flanges (that is to say overlap joints which serve to join at least two metal sheets) formed of at least two metal sheets (joining partners) by means of laser welding. The method is particularly suitable for producing welded joints between galvanized, heat-treated steel sheets, as are often used in vehicle body construction.

In automobile manufacture/vehicle body construction, flanges (galvanized steel sheets) which occur for example at door entry openings, on doors or along component edges are usually welded by means of I-welds or fillet welds.

When using the galvanized metal sheets that are customary in vehicle body construction, the quality of I-welds in the flange (overlap joint) often does not satisfy relatively high requirements due to the outgassing of zinc that occurs during the welding of zinc sheets. The bonding cross-section is limited, the welding penetration depth is difficult to reproduce (particularly when joining multiple sheets) and seam defects such as full-penetration welding, the driving-out of melt or an insufficiently deep bond. Measures to aid zinc degassing are additionally required, which are associated with additional costs. It is also disadvantageous that bonding defects (of the weld seam) cannot be detected in practice without causing destruction, since the weld seams may look perfect on the surface and yet may nevertheless be flawed.

Due to the improved possibility for degassing (of the zinc vapours), fillet welds on flanges can be produced with better quality; the seam bonding (of the joining partners) can also be inspected optically in this case. Due to the usually insufficient positioning accuracy of the laser spot for the overlap joint (of the component), however, complicated seam tracking systems must be used. In addition, the bonding cross-section cannot be increased beyond the material thickness of the top sheet, so that in many applications additional materials are necessary in order to increase the bonding cross-section. It is also disadvantageous that, in order to make the location at which the fillet seam is to be welded accessible to the processing laser, relatively large flange dimensions are required, which conflicts with the weight reduction (fuel saving) that is generally sought in vehicle manufacture.

The prior art discloses solutions in which methods and apparatuses for the front welding of metal sheets (flanges/overlap joints formed from metal sheets) are described.

For instance, there is described in WO 2011/147891 A1 an apparatus for producing front weld seams on overlap joints (formed of metal body sheets), which has a device for optical seam tracking and an accompanying clamping means. A device for the targeted heat-treatment and process-engineering treatment of the joining partners is not described, so that neither an optimal degassing nor a welding of heat-treated (hardened) metal sheets is possible with the apparatus, without the metal sheets being softened in the seam area.

DE 10 2006 030 060 A1 describes a method for the front welding of metal sheets, in particular flanges comprising sheets of high-strength materials, in which the entire front face of the flange is melted. The bonding cross-section is essentially limited by the front surface area of the flanges. The method cannot be used for the front welding of just any flange since the desired melt bath quantity is achieved only above a defined overhang of the flanges. Furthermore, the difference in the overhang of the sheets is subject to very strict tolerances, since the melt volume is directly dependent on this difference. In this case, considerable investment must be made in tools for cutting and positioning.

US 2004/01188181 A1 describes a method for welding together two steel sheets, in which the sheets are heated by means of a first laser in the area of the weld seam to be produced, so that one of the sheets is plastically deformed without melting. A second laser carries out the actual welding process. The method is said to achieve the situation whereby the two sheets have a defined degassing gap during the welding process. A front welding of multi-sheet joints is also described, this being carried out using a multi-focus lens, as a result of which it is possible to produce two or more weld seams simultaneously. One disadvantage with this method is the splitting of the available laser power between multiple spots. The intensities on the optical elements are very high in this case, because the irradiated areas on the optical elements are very small, which leads to an increased focus shift.

JP 2005199827 A describes a welding method for producing corner welds and butt welds, in which a YAG laser is guided along the weld seam to be produced, with a semiconductor laser following after this at a defined spatial distance, the semiconductor laser being less focussed than the YAG laser. In this way, weld seams having a keyhole-like cross-sectional area are said to be produced. The use of two laser sources and two laser optics is disadvantageous from the point of view of availability of the system and from the point of view of investment costs.

### SUMMARY

The invention relates to a method by which stitch welds (5) can be produced on the front faces of metal sheets (preferably on flanges) by means of laser welding. In order to produce the stitch weld seam, the following steps are repeated cyclically: pre-heating the joining partners (1, 2) in an area in front of the stitch weld seam to be produced, producing a short stitch weld section (7) at a relatively low resulting welding speed, and producing a section without a weld seam, as a result of which in each case an intermediate space (9) is formed between neighbouring stitch weld sections (7). The ratio of the lengths (6, 8) of intermediate spaces (9) and stitch weld sections (7) is selected in such a way that a degassing is achieved to such an extent that a high quality of the stitch weld seam (5) is achieved. The method is particularly suitable for producing welded joints between galvanized, heat-treated steel sheets, as are often used in automobile manufacture/vehicle body construction.

### DETAILED DESCRIPTION

The problem addressed by the invention is that of finding a method by which stitch weld seams can be applied by laser welding to the front faces of flanges (overlap joints) of any shape. With the method, the intention is to achieve high seam strengths with an optimal microstructure, wherein, in the case of welding heat-treated sheets, the thermal softening of the sheets in the heat-affected area of the stitch weld seam is also to be minimized.

The problem addressed by the invention is solved by the features of claim 1. Further advantageous embodiments of the invention are apparent from claims 2 to 11.

In the method for stitch-welding a front flange joint which comprises at least two joining partners, by means of laser welding, during the welding process a continuous advancing speed of the processing laser in the main direction of advance (approximately in the direction of the seam to be welded) is defined by the welding device.

According to the invention, for carrying out the method use is made of a beam influencing device which can (dynamically) move the laser beam independently of the continuous advance of the welding device, can change the focus of the laser beam and/or can vary the power of the laser beam (can carry out a superposed, synchronized power modulation).

During the production of the stitch weld seam, the following steps are carried out multiple times one after the other (in a cyclically repeating manner):

In a first step, the joining partners are pre-heated (in an area in front of the seam to be produced). To this end, the beam influencing device temporarily superposes on the continuous advancing speed (in the main direction of advance) of the welding device a speed (of the laser beam) in the direction of the seam to be produced. The pre-heating of the joining partners usually takes place in a manner tailored to the metallurgical (thermal) properties thereof, such as for example the heat capacities and thermal conductivities thereof.

In a next step (welding-in), a relatively short stitch weld seam (hereinafter: stitch) is produced at a relatively low resulting welding speed. Usually, in order to achieve a reduction in the resulting advancing speed, the beam influencing device superposes on the continuous speed defined by the beam influencing device a speed in the opposite direction (counter to the direction of the stitch weld seam to be produced). By reducing the resulting advancing speed, the energy per unit length, which is defined as the quotient of the laser power and the advancing speed, during the welding of the individual stitches is increased.

The production of the stitch is followed by a step in which the intermediate space between the neighbouring stitches is formed (producing a section without a weld seam). The ratio of the lengths of intermediate spaces and stitches is selected in such a manner that a good (at least sufficient) degassing of the weld seam and therefore a good (at least sufficient) seam bonding in the individual stitches is achieved. The degassing plays a particularly important role when using galvanized steel sheets, as are often used in vehicle body construction, since the zinc layer vaporizes during the welding process and (if there is insufficient degassing) the resulting so-called zinc outgassing often leads to weld seams of low seam quality (bonding defects).

After the step of producing a stitch weld seam, the joining partners are optionally processed a second time (post-treated) in the area of the stitch weld seam that has been produced, in that the beam influencing device temporarily superposes on the continuous advancing speed of the welding device a speed counter to the direction of the stitch weld seam to be produced.

The post-treatment of the stitch weld seam that has been produced may consist in that the stitch weld seam is post-welded (welded a second time), as a result of which on the one hand the melt of the weld seam penetrates deeper into the flange. On the other hand, heat is applied a second time and this has a positive effect on the martensitic microstructure and on the cooling behaviour. This is particularly advantageous when welding heat-treated (high-strength) steels, since brittle and fragile seams may be obtained when these steels are welded without additional heat input.

As an alternative, the post-treatment of the weld seam that has been produced may also consist in that, after the outgassing/the production of the intermediate space, the joining partners and/or the stitch produced are merely post-heated (but not post-welded) in that the processing laser applies heat to an area around the freshly produced stitch. The post-heating serves to reduce material stresses and to reverse in full or in part the thermal changes to joining partners made of heat-treated steel that are brought about by the welding process.

During the production of the stitch weld sections, the edges of the at least two joining partners are arranged (largely) flush, but this is not absolutely necessary. The laser beam runs preferably parallel to the flange plane and to the flange profile, but considerable deviations from the perpendicular welding position occur on account of accessibility issues on real workpieces. Customary orders of magnitude of +−10° in the YZ plane and +−30° in the XZ plane can be tolerated.

In the method according to the invention, stitches having a length of less than 30 mm (preferably less than 10 mm) and intermediate spaces larger than 1 mm between the stitch weld sections are produced, wherein the ratio of seam depth to seam length of the stitch weld sections is at least one fifth (preferably at least one third).

In one advantageous variant, during the production of (at least) one stitch, the beam influencing device may superpose on the continuous advancing speed of the welding device a speed which oscillates between the two directions in and counter to the direction of the stitch weld seam to be produced. In this way, multiple sweeping of the stitch in question (by the laser beam) is achieved.

Furthermore, during the welding of a stitch and during the pre-heating and post-heating, the beam influencing device may superpose at least temporarily on the continuous advancing speed of the welding device a speed in a direction transverse to the direction of advance. With a synchronized movement of two scanners, advantageous spot movements can thus be produced. In addition, a further degree of freedom is available by changing the focal plane of the processing laser; in this case, the spot size of the laser beam in the joint plane can be enlarged and/or the power of the processing laser can be adjusted.

By virtue of the abovementioned measures, the resulting energy per unit length can be adjusted during the production of the stitch and the local heat input can be adjusted during the pre-heating and post-heating.

The curve form of the superposition which is superposed on the continuous advancing speed in the lateral direction preferably has a periodic profile, namely a sinusoidal, square-wave or sawtooth-like profile.

With the method according to the invention, by providing sufficient possibilities for degassing, a high degree of process reliability is achieved, that is to say weld seams of reproducible high seam quality (seam bonding) are produced.

By virtue of the possibility for specific adjustment of the energy per unit length, suitable bond depths/suitable cross-sections can be produced within the individual stitches.

By coordinating the steps of pre-heating, welding-in (welding of the stitch weld sections) and optional post-heating, the processing speed can be increased.

Due to the cyclic variation of the energy per unit length and the possibility for post-welding/post-heating, joining partners made of heat-treated steels can be subjected to a specific thermal influencing during the laser welding, as a result of which areas of hardening in the heat-affected zones are largely avoided and a reliable microstructure in the welding zone is achieved.

When the method is used in vehicle body construction, an improved crash behaviour (increase in crack energy, avoidance of zip-like ruptures) is achieved due to the advantageous configuration of the stitch weld seams.

In order to check the quality of the weld seams produced, it is advantageous to use a device which either is equipped with a sensor system that serves to check the quality of the weld seam produced or the data of which are used directly to control the welding process.

It is therefore possible subsequently to determine, for example by means of a geometric measurement, whether any seam is present at all. A check can be carried out, by means of thermography, by evaluating the process light or through a keyhole observation, to ascertain whether the welding has been carried out.

The seam length can be checked by triangulation methods or by an evaluation of the process light over time at a known rate of advance.

Finally, the quality of the seam can be detected by evaluating the process emission, and an evaluation of the thermal image can take place in order to assess the thermal influencing of the at least two joining partners by the welding process.

### BRIEF DESCRIPTION OF THE DRAWINGS

The invention will be explained in more detail below on the basis of two examples of embodiments. To this end, in the drawings:

FIG. 1: shows a flange comprising two sheets as joining partners and a front stitch weld seam, in a 3D view;

FIG. 2: shows a flange comprising three sheets as joining partners and two front stitch weld seams, in a sectional view from the side,

FIG. 3: shows a flange comprising three sheets as joining partners and two front stitch weld seams, in plan view.

### DETAILED DESCRIPTION OF THE PREFERRED EMBODIMENT

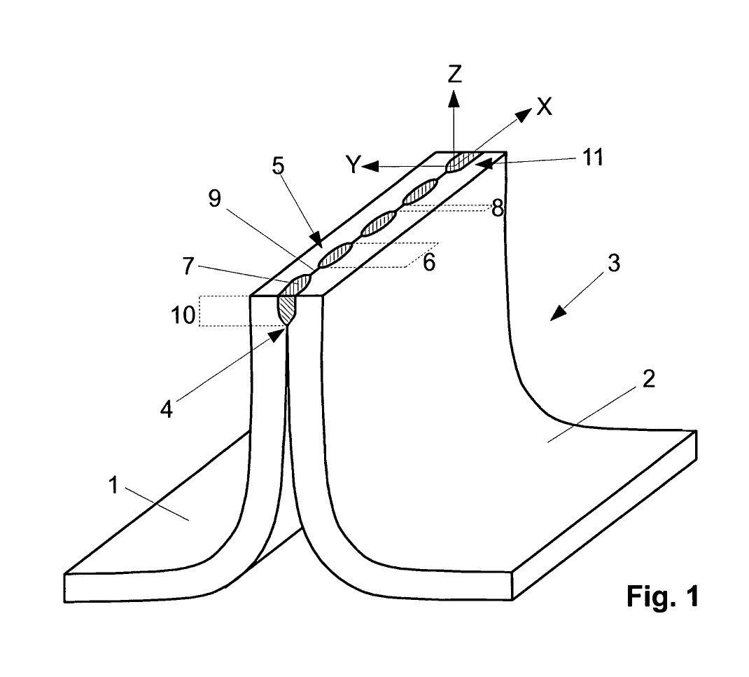

FIG. 1 shows a first sheet 1 and a second sheet 2 which are bent to form a flange 3 and which are pressed together by means of a clamping device (not shown), as a result of which the gap 4 formed between the two surfaces in the flange area is kept small. The two sheets 1, 2 (joining partners) are joined to one another by means of a front stitch weld seam 5. The length 6 of the stitches 7 extending in the direction of the stitch weld seam to be produced (running direction of the stitch weld seam; X direction) is approximately 7 mm, and the length 8 of the intermediate space 9 between neighbouring stitches 7 is 1 mm. The aspect ratio between seam length 6 and seam depth 10 is one third.

During the production of the stitch weld seam 5, the energy per unit length is adjusted (by means of a beam influencing device; not shown), if necessary, by an oscillating deflection of the laser processing beam in the lateral direction (Y direction: is perpendicular to the X direction and runs in the joint plane 11 formed by the front faces of the sheets 1, 2) and/or by changing the spot size of the laser by changing the focal plane in the Z direction (runs perpendicular both to the X direction and to the Y direction) and/or by changing the laser power.

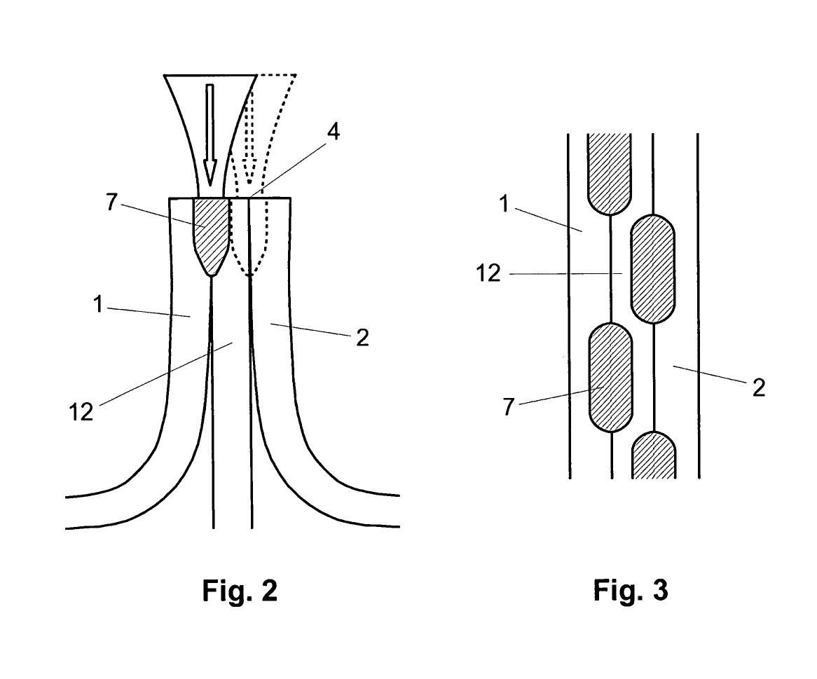

FIG. 2 shows a front stitch weld seam 5 on a flange, in which a third sheet 12 is arranged between the two sheets 1, 2. Stitches are welded in an alternating fashion (FIG. 3) onto the two gaps 4 thus formed.

### LIST OF REFERENCE NUMERALS

1 first sheet/first joining partner

2 second sheet/second joining partner

3 flange

4 gap

5 stitch weld seam

6 length of the stitch

7 stitch weld section, stitch

8 length of the intermediate space

9 intermediate space

10 seam depth

11 joint plane

12 third sheet/third joining partner

1. A method for stitch-welding a front flange joint comprising at least two joining partners (1, 2), by laser welding by means of a laser beam, in which during the welding process a continuous advancing speed of the processing optics in the main direction of advance is defined by means of the welding device, comprising the following steps which are repeated cyclically during the production of the stitch weld seam,
pre-heating the joining partners (1, 2) in an area in front of the stitch weld seam to be produced, in that a beam influencing device, by means of which the laser beam can be moved independently of the advance of the welding device, temporarily superposes on the continuous advancing speed of the welding device in the main direction of advance, by moving the laser beam, a movement speed of the laser beam in the direction of the stitch weld seam to be produced;
producing a short stitch weld section (7) at a reduced resulting welding speed, wherein the resulting welding speed is composed of the superposition of the continuous advancing speed of the welding device and the movement speed of the laser beam that is defined by the beam influencing device;
travelling over a section in the main direction of advance without forming a weld seam, as a result of which in each case an intermediate space (9) is formed between neighbouring stitch weld sections (7), wherein stitch weld sections (7) having a length (6) of less than 30 mm and intermediate spaces (9) having a length of more than 1 mm between the stitch weld sections (7) are produced.

2. The method according to claim 1, characterized in that, after the step of forming a weld seam (9), the joining partners (1, 2) are processed a second time in the area of the weld seam that has been produced, in that the beam influencing device temporarily superposes on the continuous advancing speed of the welding device a movement speed of the laser beam counter to the direction of the stitch weld seam (5) to be produced.

3. The method according to claim 1, characterized in that stitch weld sections (7) having a length of less than 10 mm are produced.

4. The method according to claim 1, characterized in that the stitch weld sections (7) are produced with a ratio of seam depth (10) to length of greater than one fifth.

5. The method according to claim 1, characterized in that, during the production of at least a portion of at least one stitch weld section (7), the beam influencing device superposes on the continuous advancing speed of the welding device a movement speed of the laser beam which alternates between the two directions in and counter to the direction of the stitch weld seam (5) to be produced, as a result of which a multiple sweeping of the portion of the stitch weld section (7) in question is achieved.

6. The method according to claim 1, characterized in that
the beam influencing device superposes at least temporarily on the continuous advancing speed of the welding device a movement speed of the laser beam in a lateral direction which runs on the one hand perpendicular to the direction of the stitch weld seam (5) to be produced and on the other hand in the joint plane (11) which is defined by the front faces of the joining partners (1, 2) forming the flange (3).

7. The method according to claim 1, characterized in that the focal plane of the laser beam is changed by means of the beam influencing device.

8. The method according to claim 1, characterized in that the power of the laser beam is varied by means of the beam influencing device.

9. The method according to claim 6, characterized in that the superposition of the movement speed of the laser beam in the lateral direction takes place by means of a periodic function.

10. The method according to claim 9, characterized in that the superposition of the movement speed of the laser beam in the lateral direction takes place in a sinusoidal, square-wave or sawtooth-like manner.

11. The method according to claim 9, characterized in that the pre-heating of the at least two joining partners (1, 2) takes place in each case in a manner tailored to the metallurgical properties thereof.

12. The method according to claim 1, characterized in that, using a sensor system which serves to check the quality of the stitch weld seam (5) produced, it is determined whether the welding has been carried out.

13. The method according to claim 1, characterized in that, using a sensor system which serves to check the quality of the stitch weld seam (5) produced, the length of the stitch weld sections (7) or of the entire stitch weld seam (5) is checked by triangulation methods or by an evaluation of the process light over time at a known rate of advance.

14. The method according to claim 1, characterized in that the quality of the stitch weld seam (5) is detected by evaluating the process emission.

15. The method according to claim 1, characterized in that, using a sensor system, the data of which are used to further control the welding process, an evaluation of the thermal image is carried out in order to assess the thermal influencing of the at least two joining partners (1, 2) by the welding process.
